(19) United States
(12) Patent Application Publication
(10) Pub. No.: US 2012/0137228 A1
(43) Pub. Date: May 31, 2012

(54) POINT-TO-POINT FILE TRANSMITTING DEVICE AND FILE TRANSMITTING METHOD THEREOF

(75) Inventor: Ching-Wei Cheng, Keelung City (TW)

(73) Assignee: ACTION STAR ENTERPRISE CO. LTD., Sijhih (TW)

(21) Appl. No.: 12/956,216

(22) Filed: Nov. 30, 2010

(51) Int. Cl. G06F 3/048; G06F 3/14; G06F 15/16

(52) U.S. Cl. 715/748; 709/217; 715/769

(57) ABSTRACT

The present invention relates to a point-to-point file transmitting device and a file transmitting method thereof, the point-to-point file transmitting device comprises: at least one first USB connecting unit, at least one second USB connecting unit, at least one micro-control unit, and a network transmission application, wherein the first USB connecting unit connects to a first host, the second USB connecting unit connects to a second host, and the network transmission application are respectively installed in the first host and the second host; so that, through the network transmission application, a network transmission channel is established between the first host and the second host used for files sharing and data transmission. Besides, by way of the file transmitting method, the files sharing and data transmission can be completed between the first host and the second host when the network transmission applications installed in the two hosts are executed.

### BACKGROUND OF THE INVENTION

1. Technical Field

The present invention relates to a file transmitting device used between multi hosts, and more particularly, to a point-to-point file transmitting device and a file transmitting method thereof, in which, through the point-to-point file transmitting device and the file transmitting method thereof, a network transmission channel can be established between the multi hosts used for file sharing and data transmission.

2. Description of Related Art

There are many methods adapted for executing file sharing and data transmission between multi computers. For example, if an A computer and a B computer are belonged to a computer group, such as a office computer group or a laboratory computer group, a network transmission channel can be established between the A computer and the B computer through an internal network, so as to completed file sharing and data transmission in the A computer and the B computer via the network transmission channel.

Please refer to FIGS. 1A and 1B, which illustrate flow charts of executing file sharing by using the internal network. As shown in FIG. 1A and FIG. 1B, when it desires to executing file sharing and data transmission between two computers through the internal network, it needs to execute a setting flow consisting the steps of:

Firstly, executing step (101), opening the Network Neighborhood. The setting flow next proceeds to step (102), searching the A computer, and next proceeding to step (103), determining whether the A computer is found, if yes, proceeding to step (104), connecting to the A computer. When it connects to the A computer, a user account and a user password must to be inputted for checking user privileges in step (105). The setting flow Next proceeding to step (106), determining whether the user account and the user password are correct, if yes, proceeding to step (107), completing the connection with the A computer. After step (107) is finished, proceeding to step (108), finding the file-sharing folder in the A computer; and next proceeding to step (109), executing file sharing and data transmission. However, in the step (106), if no, the setting flow proceeds to step (10A), it can not complete the connection with the A computer. In addition, in the step (103), if no, that means the A computer is not belonged to the computer group, so that, the setting flow also proceeds to the step (10A).

For the above-mentioned setting flow of can find the A computer by searching the computer name and the international position thereof Besides, when setting the file-sharing folders, it must set file-sharing folders for allowing other users to read and write. However, according to the above-mentioned setting flow of using the internal network to share file and transmit data between two computers, it is easily to know that the steps of the setting flow are complex, so that the common computer users can not easily to finished the setting flow and using the internal network to complete file sharing and data transmission between two computers.

Accordingly, another method adapted for file sharing and data transmission by using a server host is proposed. Please refer to FIG. 2, a schematic framework diagram of using the server host to execute file sharing and data transmission is illustrated. As shown in FIG. 2, the A computer l′ is able to upload files and data to the server host 2′ via a specific network transmission way, for instance, FTP and E-mail, thus, the B computer 3′ can download the files and data through the internet network. It is easily to understand that is the simplest method for file sharing and data transmission by using the server host, however, this method has an essential drawback: the A computer and the B computer must to login the server host in turns for respectively unloading and downloading files.

Moreover, with the rapid development of the Instant Messaging (IM) software, users also can execute file sharing and data transmission between the A computer and the B computer through the network transmission channel established by the IM software. However, when using the IM software to transmit files and data between the A computer and the B computer, it needs two IM user accounts to login the IM software installed in the A computer and the B computer, respectively; Then, by way of the instant messaging of the two user accounts, the files and data can be transmitted in the A computer and the B computer.

Accordingly, in view of the conventional methods for sharing files and transmitting data still have shortcomings and drawbacks, the inventor of the present application has made great efforts to make inventive research thereon and eventually provided a point-to-point file transmitting device and a file transmitting method thereof

### BRIEF SUMMARY OF THE INVENTION

The first objective of the present invention is to provide a point-to-point file transmitting device, so that a network transmission channel can be established between a first host and a second host through a network transmission application without any other complex setting procedures, moreover, the file sharing and the data transmission are carried out between the first host and the second host via the network transmission channel.

The second objective of the present invention is to provide a point-to-point file transmitting device, so that a network transmission channel can be established between a first host and a second host through a network transmission application without any other complex setting procedures, moreover, by way of wireless transmission, the file sharing and the data transmission are carried out between the first host and the second host via the network transmission channel, and it is able to avoid the cables connected the hosts and the point-to-point file transmitting device being over extended and winded.

The third objective of the present invention is to provide a file transmitting method, through the file transmitting method, a network transmission channel is able to be established in a first host and a second host connected to a point-to-point file transmitting device, such that the files and data in the first host can be moved and copied to the second host via the network transmission channel, moreover, the files and data in the second host also can be moved and copied to the first host via the network transmission channel.

Thus, to achieve the first objective of the present invention, the inventor proposes a point-to-point file transmitting device, capable of being connected to a plurality of hosts with a first host and a second host, and comprises: at least one first USB connecting unit, at least one second USB connecting unit, at least one micro-control unit, and a network transmission application.

The least one first USB connecting unit is electrically connected to the first host with a first display device and a first operation device. The second USB connecting unit is electrically connected to the second host having a second display device and a second operation device. The micro-control unit is coupled to the first USB connecting unit and the second USB connecting unit. The network transmission application is installed in the first host and the second host, respectively. Through the network transmission application, a network transmission channel is established between the first host and the second host used for file sharing and data transmission; moreover, by way of the network transmission channel, the files and data in the first host can be moved and copied to the second host, and similarly, the files and data in the second host also can be moved and copied to the first host.

The network transmission channel defined by the network transmission application has a specific network communication port with a specific code, so that, except for the first host and the second host having the network transmission application, others external hosts can not move files and copy data to the first host and the second host through the specific network communication port.

To achieve the second objective of the present invention, the inventor proposes a point-to-point file transmitting device, capable of being connected to a plurality of hosts with a first host and a second host, and comprises: a network transmission applications, at least one first connecting module and at least one second connecting module, wherein the network transmission applications is respectively installed in the first host and the second host, moreover, through the network transmission applications, a network transmission channel is established between the first host and the second host used for file sharing and data transmission.

The first connecting module is electrically connected to the first host having a first display device and a first operation device and able to transmit the files and data in the first host by way of wireless transmission, the first connecting module comprises: a first USB connecting unit, electrically connected to the first host for receiving the files and data; a first micro-control unit, coupled to the first USB connecting unit; and a first wireless transmission unit, coupled to the first micro-control unit. Wherein when the first micro-control unit transmits the files and data to the first wireless transmission unit, the first wireless transmission unit sends the files and data out by means of wireless transmission.

The second connecting module is electrically connected to the second host having a second display device and a second operation device and able to transmit the files and data in the second host by way of wireless transmission, the second connecting module comprises: a second USB connecting unit, electrically connected to the second host; a second micro-control unit, coupled to the second USB connecting unit; and a second wireless transmission unit, coupled to the second micro-control unit. Wherein the second wireless transmission unit can receive the files and data sent out by the first wireless transmission unit through wireless transmission and transmit the files and data to the second micro-control unit, so as to further transmit the files and data to the second host via the second USB connecting unit.

Wherein the network transmission channel has a specific network communication port with a specific code, moreover, when the first host and the second host are boosted, the network transmission applications automatically access the specific code of the network communication port to establish the network transmission channel between the first host and the second host.

Moreover, To achieve the third objective of the present invention, the inventor proposes a file transmitting method comprising the steps of: (1) connecting a first host with a first display device and a first operation device to a point-to-point file transmitting device, and connecting a second host having a second display device and a second operation device to the point-to-point file transmitting device; (2) detecting whether the first host and the second host have been installed a network transmission application by a micro-control unit 13, if yes, proceeding to step (4), otherwise, proceeding to step (3); (3) installing the network transmission application in all hosts, proceeding back to step (2); (4) executing the network transmission applications installed in the first host and the second host; (5) establishing a network transmission channel with a specific network communication port between the first host and the second host; (6) automatically accessing the international positions (IP) of the first host and the second host and a specific code of the specific network communication port by the network transmission applications; (7) determining whether to move and copy the files and data from the first host to the second host, if yes, proceeding to step (8), otherwise, proceeding to step (9); (8) moving files and copying data from the first host to the second host via the network transmission channel; (9) determining whether to move and copy the files and data from the second host to the first host, if yes, proceeding to step (10), otherwise, proceeding to step (11); (10) moving files and copying data from the second host to the first host through the network transmission channel; and (11) determining whether the file transmission and data copy are completed, if yes, ending the steps, otherwise, proceeding to step (7).

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIGS. 1A and 1B are flow charts of executing file sharing by using an internal network;

FIG. 2 is a schematic framework diagram of using a server host to execute file sharing and data transmission;

FIGS. 3 and 4 are framework diagrams of a first embodiment of a point-to-point file transmitting device according to the present invention;

FIG. 5 is the framework diagram of a second embodiment of the point-to-point file transmitting device according to the present invention;

FIG. 6 is the framework diagram of a third embodiment of the point-to-point file transmitting device according to the present invention;

FIG. 7 is the framework diagram of a fourth embodiment of the point-to-point file transmitting device according to the present invention;

FIGS. 8 and 9 are the framework diagrams of a fifth embodiment of the point-to-point file transmitting device according to the present invention;

FIG. 10 is the framework diagram of a sixth embodiment of the point-to-point file transmitting device according to the present invention;

FIGS. 11A, 11B and 11C are flow charts of a file transmitting method according to the present invention;

FIG. 12 is flow chart of the detail steps of step (808) of the file transmitting method according to the present invention;

FIG. 13 is flow chart of the second detail steps of step (808) of the file transmitting method according to the present invention; and

FIG. 14 is flow chart of the third detail steps of step (808) of the file transmitting method according to the present invention.

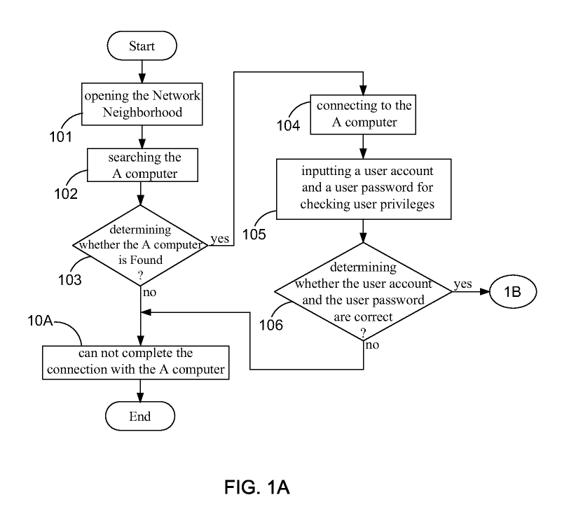

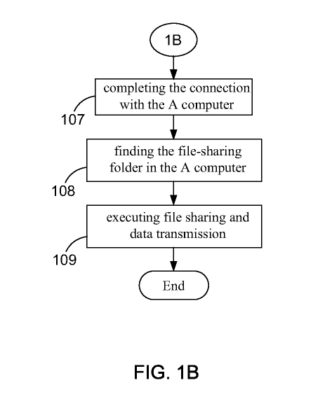

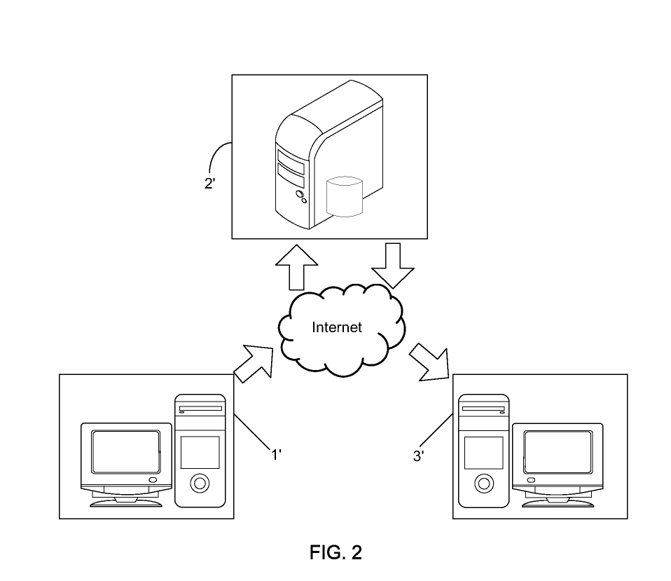

### DETAILED DESCRIPTION OF THE INVENTION

To more clearly describe a point-to-pint file transmitting device and a file transmitting method thereof according to the present invention, embodiments of the present invention will be described in detail with reference to the attached drawings hereinafter.

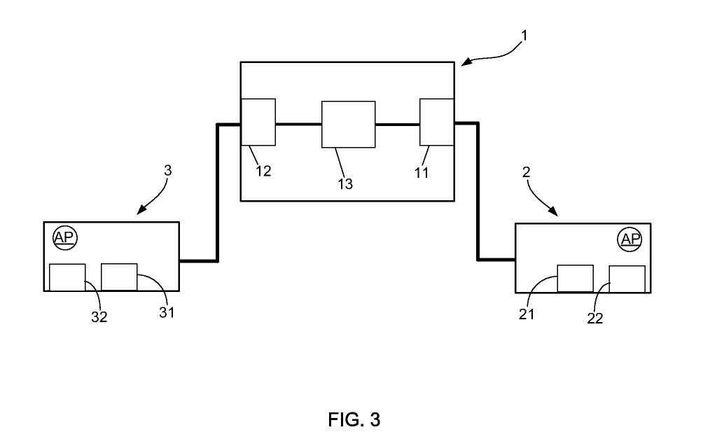

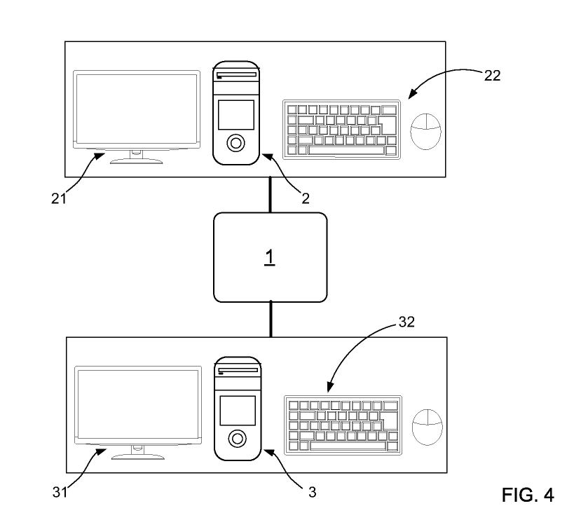

According to the present invention, please refer to FIG. 3 and FIG. 4, which illustrate framework diagrams of a first embodiment of the point-to-point file transmitting device. As shown in FIG. 3 and FIG. 4, the point-to-point file transmitting device 1 is connected to a first host 2 and a second host 3, and includes: a first USB connecting unit 11, a second USB connecting unit 12, a micro-control unit 13, and a network transmission application AP.

In the first embodiment of the point-to-point file transmitting device 1, the first USB connecting unit 11 is electrically connected to the first host 2 with a first display device 21 and a first operation device 22, and the second USB connecting unit 12 is electrically connected to the second host 3 having a second display device 31 and a second operation device 32, wherein the first host 2 and the second host 3 can be a desktop computer, a notebook or a netbook, and the first operation device 22 and the second operation device 32 are both a keyboard and mouse set.

The micro-control unit 13 is coupled to the first USB connecting unit 11 and the second USB connecting unit 13. The network transmission application AP is installed in the first host 2 and the second host 3, respectively. Through network transmission application AP, a network transmission channel is established between the first host 2 and the second host 3 used for file sharing and data transmission; moreover, by way of the network transmission channel, the files and data in the first host 2 can be moved and copied to the second host 3, and similarly, the files and data in the second host 3 also can be moved and copied to the first host 2. The network transmission channel established by the network transmission application AP has a specific network communication port with a specific code, wherein the specific code is a number between 1 and 65535 the same to the TCP (Transmission Control Protocol).

In the above description, the framework of the first embodiment of the point-to-point file transmitting device 1 has been disclosed, and furthermore, the characteristics and the functionality of the point-to-point file transmitting device 1 will be described in follows. For the first embodiment of the point-to-point file transmitting device 1 shown in FIG. 3, wherein when the first host 2 and the second host 3 installed the network transmission application AP are boosted, the network transmission applications AP automatically access the international positions (IP) of the two hosts and the code number of the network communication port, therefore a closed network transmission channel is established in the first host 2 and the second host 3; Besides, Since the network communication port has the specific code number, others external hosts can not move files and copy data to the first host 2 and the second host 3 through the specific network communication port.

Moreover, when the first host 2 is used, the point-to-point file transmitting device 1 provides three file transmitting ways for users to move files and copy data from the first host 2 to the second host 3 consisting of:

(1) dragging files: when the first host 2 is used, the files and data in the first host 2 are capable of being dragged in the first display device 21 by using the first operation device 22, and the files and data in the first host 2 can be further dragged out of the screen of the first display device 21, so as to move files and copy data to the second host 3.

(2) opening a default desktop window: when the first host 2 is used, a default desktop window of the second host 3 can be opened on the first display device 21 through the network transmission applications AP, such that the files and data in the first host 2 are able to be moved and copied to the second host 3 by moving the files and data from the desktop window of the first host 2 to the default desktop window of the second host 3.

(3) opening an Explorer: when the first host 2 is used, an Explorer of the second host 3 can be opened on the first display device 21, such that the files and data in the first host 2 are able to be moved and copied to the second host 3 by moving the files and data from the first host 2 to the Explorer of the second host 3.

Of course, when the second host 3 is used, the above-mentioned three file transmitting ways also can be adopted to move files and copy data from the second host 3 to the first host 2.

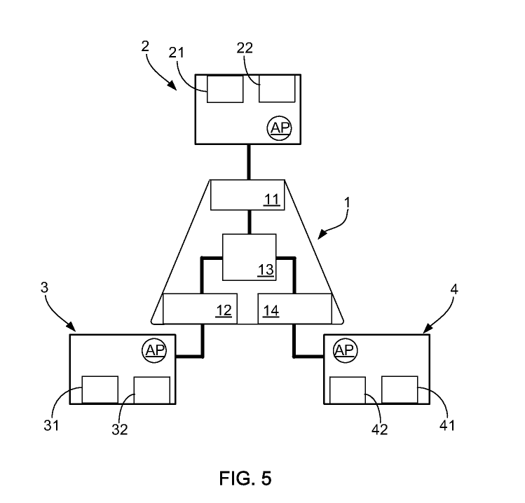

In addition to the first embodiment, the point-to-point file transmitting device 1 further has a second embodiment. Please refer to FIG. 5, the framework diagram of the second embodiment of the point-to-point file transmitting device is illustrated. As shown in FIG. 5, the second embodiment of the point-to-point file transmitting device 1 is carried out by adding a third USB connecting unit 14 into the first embodiment thereof. In the second embodiment, the third USB connecting unit 14 is connected to the micro-control unit 13 as well as a third host 4 with a third display device 41 and a third operation device 42. Thus, when the first host 2, the second host 3 and the third host 4 are boosted, the network transmission applications AP installed in the first host 2, the second host 3 and the third host 4 automatically access the international positions (IP) of the three hosts and the code number of the network communication port, so that, the closed network transmission channel is established in the first host 2, the second host 3 and the third host 4; meanwhile, through the three file transmitting ways, the files and data in the first host 2 can be moved and copied to the second host 3 and the third host 4; and similarly, the files and data in the third host 4 can be moved and copied to the first host 2 and the second host 3.

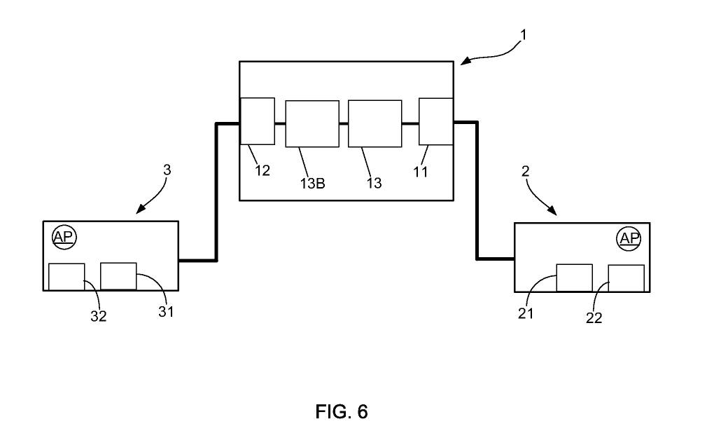

According to the disclosure of the first embodiment and the second embodiment of the point-to-point file transmitting device 1, it is easily to know that multi network transmission channels may be established between multi hosts by way of the expansion of the USB connecting unit, so that the multi hosts can transmit files and data to each other via the network transmission channels. However, when the point-to-point file transmitting device 1 is used to connect multi hosts at the same time, meanwhile, for increasing the transmission performance of the files and data, the number of the micro-control unit 13 is must to be increased. Please refer to FIG. 6, which illustrated the framework diagram of a third embodiment of the point-to-point file transmitting device according to the present invention. As shown in FIG. 6, a second micro-control unit 13B is added into the first embodiment of the point-to-point file transmitting device 1 for carrying out the third embodiment thereof.

Referring to FIG. 6 again, when it wants to move the file from the first host 2 to the third host 3, the file is firstly transmitted from the first host 2 to the micro-control unit 13, and then, the file is transmitted to the second host 3 through the second micro-control unit 13B. So that, by the transmitting way of using two micro-control units (13 and 13B), it is able to avoid that the single micro-control unit gets into a busy condition when communicating with two (or multi) hosts.

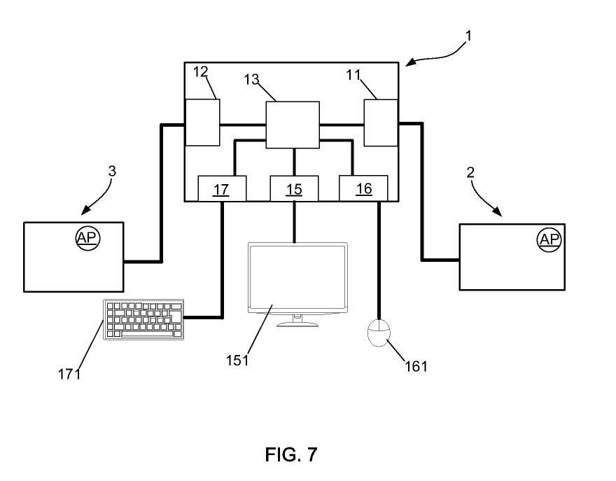

Moreover, the point-to-point file transmitting device 1 of the present invention can also be used as a KVM device. Referring to FIG. 7, the framework diagram of a fourth embodiment of the point-to-point file transmitting device according to the present invention is illustrated. As shown in FIG. 7, after adding a video connecting unit 15, a mouse connecting unit 16 and a keyboard connecting unit 17 into the first embodiment of the point-to-point file transmitting device 1, the fourth embodiment of the point-to-point file transmitting device 1 is completed. In the fourth embodiment, the video connecting unit 15, the mouse connecting unit 16 and the keyboard connecting unit 17 are all coupled to the micro-control unit 13; In addition, a common display device 151 is electrically connected to the video connecting unit 15, a common mouse device 161 is electrically connected to the mouse connecting unit 16, and a common keyboard device 171 is electrically connected to the keyboard connecting unit 17. Therefore, it is able to simultaneously control the first host 2 and the second host 3 by using the common mouse device 161 and common keyboard device 171, and furthermore, to move files and copy data in the first host 2 and the second host 3.

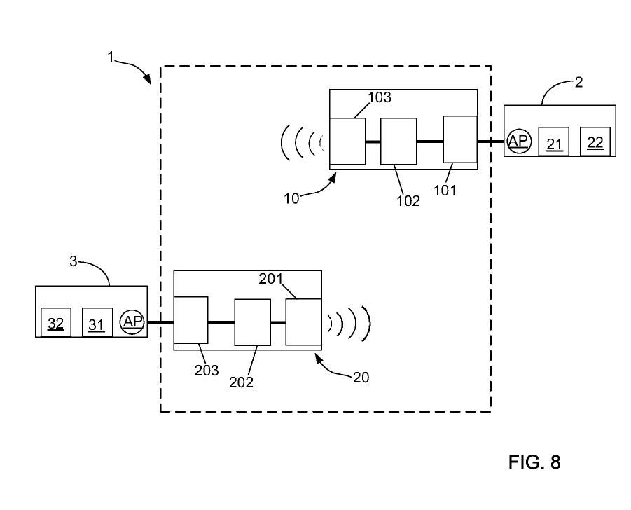

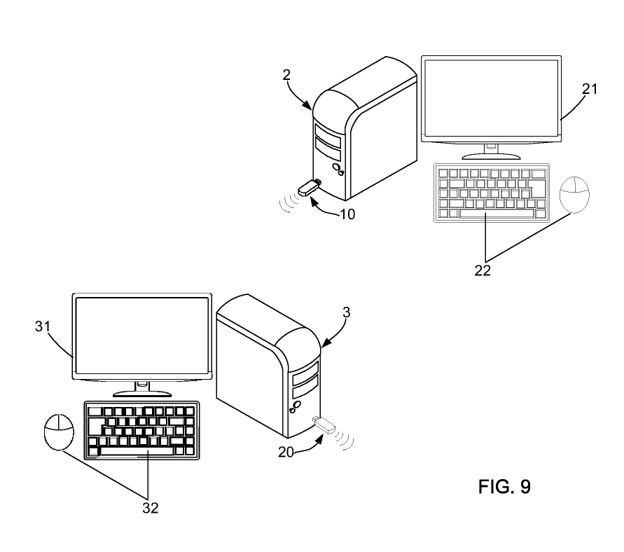

When the first host 2 must to be distanced with the second host 3 in certain distance, a fifth embodiment of the point-to-point file transmitting device 1 is proposed in the present invention in order to prevent the cable connected the first host 2 and the second host 3 being over extended and winded. Please refer to FIG. 8 and FIG. 9, which illustrate the framework diagrams of the fifth embodiment of the point-to-point file transmitting device according to the present invention. As shown in FIG. 8, the fifth embodiment of the point-to-point file transmitting device 1 comprises: the network transmission application AP, a first connecting module 10 and a second connecting module 20. The same to the first embodiment, the network transmission application AP in the fifth embodiment of the point-to-point file transmitting device 1 is respectively installed in the first host 2 and the second host 3, so that the network transmission channel is established between the first host 2 and the second host 3 by the network transmission applications AP.

The first connecting module 10 is electrically connected to the first host 2 having the first display device 21 and the first operation device 22, and able to transmit the files and data in the first host 2 by way of wireless transmission, the first connecting module 10 included: a first USB connecting unit 101, electrically connected to the first host 2 for receiving the files and data; a first micro-control unit 102, coupled to the first USB connecting unit 101; and a first wireless transmission unit 103, coupled to the first micro-control unit 102. When the first micro-control unit 102 transmits the files and data to the first wireless transmission unit 103, the first wireless transmission unit 103 sends the files and data out through the wireless transmission.

The second connecting module 20 is electrically connected to the second host 3 having the second display device 31 and the second operation device 32, and able to transmit the files and data in the second host 3 by way of the wireless transmission, the second connecting module 20 includes: a second USB connecting unit 203, electrically connected to the second host 3; a second micro-control unit 202, coupled to the second USB connecting unit 203; and a second wireless transmission unit 201, coupled to the second micro-control unit 202. The second wireless transmission unit 201 can receive the files and data sent out by the first wireless transmission unit 103 through wireless transmission and transmit the files and data to the second micro-control unit 202, so as to further transmit the files and data to the second host 3 via the second USB connecting unit 203.

The same to the first embodiment, in the fifth embodiment of the point-to-point file transmitting device 1, the network transmission channel has the specific network communication port with the specific code number between 1 and 65535. When the first host 2 and the second host 3 are boosted, the network transmission applications AP automatically access the international positions (IP) of the first host 2 and the second host 3 and the specific code of the network communication port, so as to establish the network transmission channel between the two hosts. In addition, the above-mentioned three file transmitting ways also can be adopted to move files and copy data from the first host 2 to the second host 3; or, to move files and copy data from the second host 3 to the first host 2.

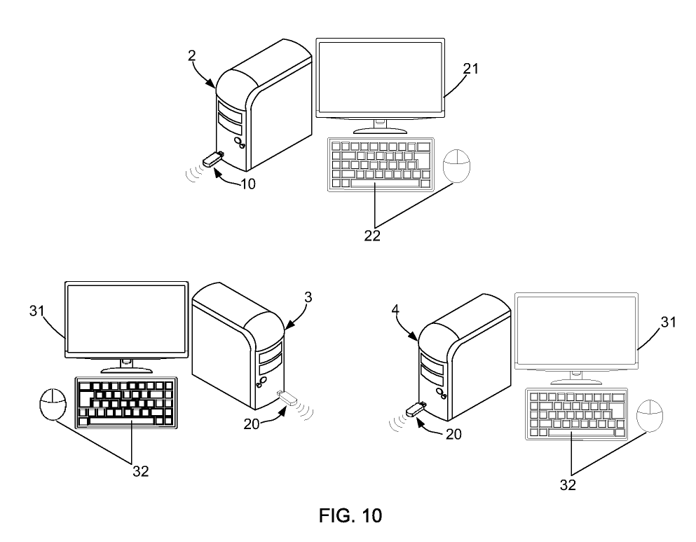

Please refer to FIG. 10, the framework diagram of a sixth embodiment of the point-to-point file transmitting device according to the present invention is illustrated. As shown in FIG. 10, a sixth embodiment of the point-to-point file transmitting device is carried out by adding a second connecting module 20 into the fifth embodiment thereof. The second connecting module 20 is connected to the third host 4 with the third display device 4 and the third operation device 42. When the first host 2, the second host 3 and the third host 4 are boosted, the network transmission applications AP automatically access the international positions (IP) of the first host 2, the second host 3 and the third host 4 as well as the specific code of the network communication port, such that the network transmission channel is established between the three hosts. Therefore, through the above-mentioned three file transmitting ways, the files and data can be moved or copy in three hosts by way of the wireless transmission.

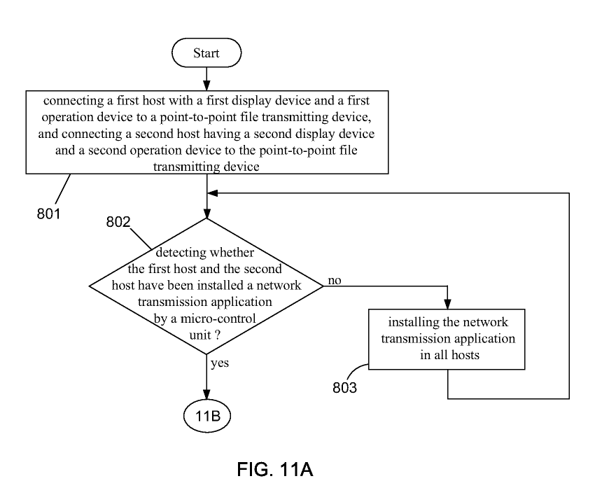

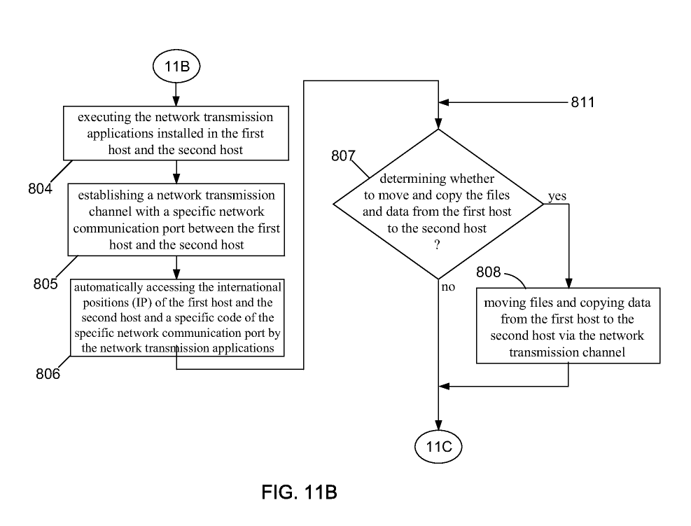

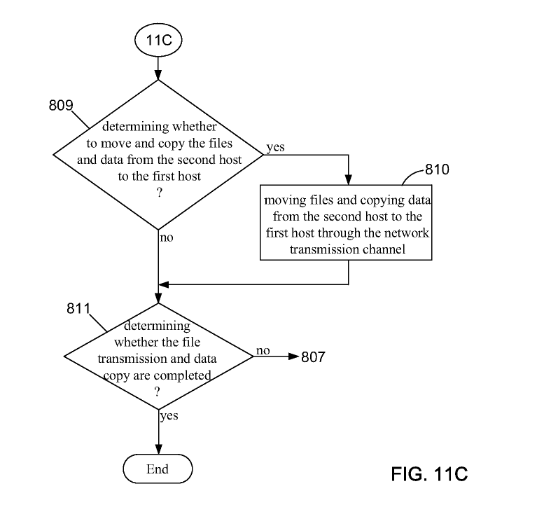

Moreover, the file transmitting method used in the point-to-point file transmitting device will be disclosed in following description. Please refer to FIGS. 11A, 11B and 11C, which illustrate flow charts of the file transmitting method according to the present invention. As shown in FIGS. 11A, 11B and 11C, the file transmitting method of the point-to-point file transmitting device 1 includes the steps of:

Firstly, executing step (801), connecting the first host 2 with the first display device 21 and the first operation device 22 to the point-to-point file transmitting device 1, and connecting the second host 3 having the second display device 31 and the second operation device 32 to the point-to-point file transmitting device 1. Next proceeding to step (802), detecting whether the first host 2 and the second host 3 have been installed the network transmission application AP by the micro-control unit 13, if yes, proceeding to step (804), otherwise, proceeding to step (803).

When the flow is proceeded to step (803), the network transmission application AP is respectively installed in all hosts, and consequently proceeding back to step (802). When the flow is proceeded to step (804), executing the network transmission applications AP installed in the first host 2 and the second host 3; and consequently proceeding to step (805), to establish the network transmission channel with the specific network communication port between the first host 2 and the second host 3. After the step (805) is completed, the flow proceeds to step (806), automatically accessing the international positions (IP) of the first host 2 and the second host 3 and the specific code of the specific network communication port by the network transmission applications AP.

Then, step (807) is executed, that is, determining whether to move and copy the files and data from the first host 2 to the second host 3, if yes, proceeding to step (808), otherwise, proceeding to step (809). When the flow is proceeded to the step (808), the files/data are move and copied from the first host 2 to the second host 3 via the network transmission channel; moreover, when the flow is proceeded to the step (809), it is to determine whether moving and copying the files and data from the second host 3 to the first host 2, if yes, proceeding to step (810), otherwise, proceeding to step (811). So that, when step (810) is executed, it moves files and copies data from the second host to the first host through the network transmission channel. Finally, in step (811), it determines whether the file transmission and data copy are completed, if yes, ending the steps, otherwise, proceeding to step (807).

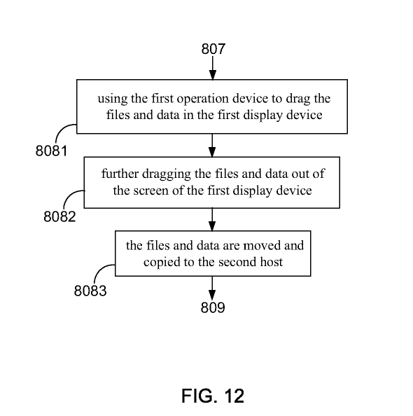

It is necessary to noted that, in the above-described file transmitting method, the step (808) further includes multi detailed steps. Referring to FIG. 12, the detailed steps of the step (808) according to the present invention is illustrated. As shown in FIG. 12, the step (808) includes the detailed steps of: step (8081), using the first operation device 22 to drag the files and data in the first display device 21; step (8082), further dragging the files and data out of the screen of the first display device 21; and step (8083), the files and data are moved and copied to the second host 3.

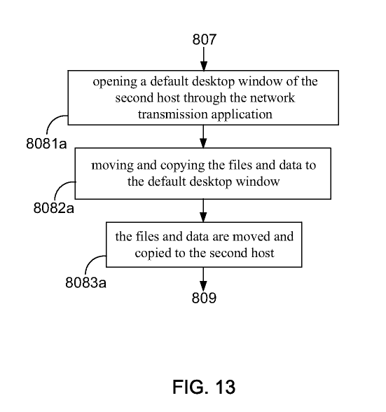

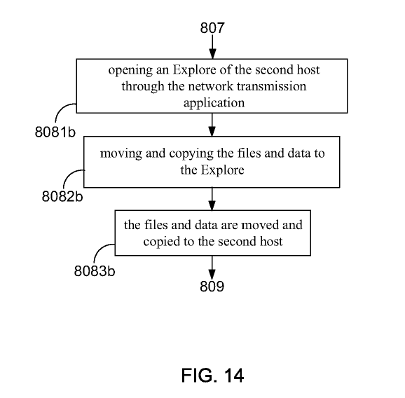

Besides, Please refer to FIG. 13, the second detailed steps of the step (808) according to the present invention is illustrated. As shown in FIG. 12, the step (808) includes the second detailed steps of: step (8081a), opening a default desktop window of the second host 3 through the network transmission application AP; step (8082a), moving and copying the files and data to the default desktop window; and step (8083a), the files and data are moved and copied to the second host 3.

Moreover, referring to FIG. 13, the third detailed steps of the step (808) according to the present invention is illustrated. As shown in FIG. 12, the step (808) includes the third detailed steps of: step (8081b), opening an Explore of the second host 3 through the network transmission application AP; step (8082b), moving and copying the files and data to the Explore; and step (8083b), the files and data are moved and copied to the second host 3.

Thus, the all embodiments of the point-to-point file transmitting device and the file transmitting method thereof according to the present invention have been disclosed completely and clearly in the above description. In summary, the present invention has the following advantages:
1. The point-to-point file transmitting device can be used as one file transmitting device or one KVM device.
2. Through the point-to-point file transmitting device, a network transmission channel can be established between multi hosts by a network transmission application without any other complex setting procedures, so that the files and data are able to be moved or copied in the multi hosts via the network transmission channel.
3. By way of the wireless transmission, the point-to-point file transmitting device can also carry out the file sharing and the data transmission in the multi hosts, therefore, it is able to avoid the cables connected the multi hosts and the point-to-point file transmitting device being over extended and winded.

The above description is made on embodiments of the present invention. However, the embodiments are not intended to limit scope of the present invention, and all equivalent implementations or alterations within the spirit of the present invention still fall within the scope of the present invention.

I claim:

1. A point-to-point file transmitting device, being connected to a plurality of hosts with a first host and a second host, comprising:
at least one first USB connecting unit, being electrically connected to the first host with a first display device and a first operation device;
at least one second USB connecting unit, being electrically connected to the second host having a second display device and a second operation device;
at least one micro-control unit, being coupled to the first USB connecting unit and the second USB connecting unit; and
a network transmission application, being installed in the first host and the second host, respectively, wherein a network transmission channel is established between the first host and the second host and used for file sharing and data transmission through the network transmission application, moreover, by way of the network transmission channel, the files and data in the first host can be moved and copied to the second host, and similarly, the files and data in the second host also can be moved and copied to the first host;
wherein the network transmission channel established by the network transmission application has a specific network communication port with a specific code, so that, except for the first host and the second host having the network transmission application, others external hosts can not move files and copy data to the first host and the second host through the specific network communication port.

2. The point-to-point file transmitting device of claim 1, wherein the specific code of the network communication port is a number between 1 and 65535.

3. The point-to-point file transmitting device of claim 2, wherein when the first host and the second host having the network transmission application are boosted, the network transmission applications automatically accessing the international positions (IP) of the two hosts and the code number of the network communication port.

4. The point-to-point file transmitting device of claim 1, wherein when the first host is used, the files and data in the first host being able to be dragged in the first display device by using the first operation device, and the files and data in the first host can be further dragged out of the screen of the first display device, so as to move and copy the files and data to the second host.

5. The point-to-point file transmitting device of claim 1, wherein when the first host is used, a default desktop window of the second host can be opened on the first display device through the network transmission applications, such that the files and data in the first host are able to be moved and copied to the second host by moving the files and data from the desktop window of the first host to the default desktop window of the second host.

6. The point-to-point file transmitting device of claim 1, wherein when the first host is used, an Explorer of the second host can be opened on the first display device, such that the files and data in the first host are able to be moved and copied to the second host by moving the files and data from the first host to the Explorer of the second host.

7. The point-to-point file transmitting device of claim 1, wherein when the second host is used, the files and data in the second host being able to be dragged in the second display device through the second operation device, and the files and data in the second host can be further dragged out of the screen of the second display device, so as to move and copy the files and data to the first host.

8. The point-to-point file transmitting device of claim 1, wherein when the second host is used, a default desktop window of the first host can be opened on the second display device through the network transmission applications, such that the files and data in the second host are able to be moved and copied to the first host by moving the files and data from the desktop window of the second host to the default desktop window of the first host.

9. The point-to-point file transmitting device of claim 1, wherein when the second host is used, an Explorer of the first host can be opened on the second display device, such that the files and data in the second host are able to be moved and copied to the first host by moving the files and data from the second host to the Explorer of the first host.

10. The point-to-point file transmitting device of claim 1, wherein the first host is selected from the group consisting of: a desktop computer, a notebook and a netbook.

11. The point-to-point file transmitting device of claim 1, wherein the second host is selected from the group consisting of: a desktop computer, a notebook and a netbook.

12. A point-to-point file transmitting device, being connected to a plurality of hosts with a first host and a second host, comprising:
a network transmission applications, being respectively installed in the first host and the second host, wherein a network transmission channel is established between the first host and the second host and used for file sharing and data transmission through the network transmission applications;
at least one first connecting module, being electrically connected to the first host having a first display device and a first operation device and able to transmit the files and data in the first host by way of wireless transmission, the first connecting module comprising:
a first USB connecting unit, being electrically connected to the first host for receiving the files and data;
a first micro-control unit, being coupled to the first USB connecting unit; and
a first wireless transmission unit, being coupled to the first micro-control unit, wherein when the first micro-control unit transmits the files and data to the first wireless transmission unit, the first wireless transmission unit sending the files and data out by means of wireless transmission; and
at least one second connecting module, being electrically connected to the second host having a second display device and a second operation device and able to transmit the files and data in the second host by way of wireless transmission, the second connecting module comprising:
a second USB connecting unit, being electrically connected to the second host;
a second micro-control unit, being coupled to the second USB connecting unit; and
a second wireless transmission unit, being coupled to the second micro-control unit, wherein the second wireless transmission unit can receive the files and data sent out by the first wireless transmission unit through wireless transmission and transmit the files and data to the second micro-control unit, so as to further transmit the files and data to the second host via the second USB connecting unit;
wherein the network transmission channel has a specific network communication port with a specific code, moreover, when the first host and the second host are boosted, the network transmission applications automatically access the specific code of the network communication port, so as to establish the network transmission channel between the first host and the second host.

13. The point-to-point file transmitting device of claim 12, wherein the specific code of the network communication port is a number between 1 and 65535.

14. The point-to-point file transmitting device of claim 12, wherein when the first host is used, the files and data in the first host being able to be dragged in the first display device through the first operation device, and the files and data in the first host can be further dragged out of the screen of the first display device, so as to move and copy the files and data to the second host.

15. The point-to-point file transmitting device of claim 12, wherein when the first host is used, a default desktop window of the second host can be opened on the first display device through the network transmission applications, such that the files and data in the first host are able to be moved and copied to the second host by moving the files and data from the desktop window of the first host to the default desktop window of the second host.

16. The point-to-point file transmitting device of claim 12, wherein when the first host is used, the Explorer of the second host can be opened on the first display device, such that the files and data in the first host are able to be moved and copied to the second host by moving the files and data from the first host to the Explorer of the second host.

17. The point-to-point file transmitting device of claim 12, wherein when the second host is used, the files and data in the second host being able to be dragged in the second display device through the second operation device, and the files and data in the second host can be further dragged out of the screen of the second display device, so as to move and copy the files and data to the first host.

18. The point-to-point file transmitting device of claim 12, wherein when the second host is used, a default desktop window of the first host can be opened on the second display device through the network transmission applications, such that the files and data in the second host are able to be moved and copied to the first host by moving the files and data from the desktop window of the second host to the default desktop window of the first host.

19. The point-to-point file transmitting device of claim 12, wherein when the second host is used, the Explorer of the first host can be opened on the second display device, such that the files and data in the second host are able to be moved and copied to the first host by moving the files and data from the second host to the Explorer of the first host.

20. The point-to-point file transmitting device of claim 12, wherein the first host is selected from the group consisting of: a desktop computer, a notebook and a netbook.

21. The point-to-point file transmitting device of claim 12, wherein the second host is selected from the group consisting of: a desktop computer, a notebook and a netbook.

22. A file transmitting method, comprising the steps of:
(1) connecting a first host with a first display device and a first operation device to a point-to-point file transmitting device 1, and connecting a second host having a second display device and a second operation device to the point-to-point file transmitting device;
(2) detecting whether the first host and the second host have been installed a network transmission application AP by a micro-control unit, if yes, proceeding to step (4), otherwise, proceeding to step (3);
(3) installing the network transmission application in all hosts, proceeding back to step (2);
(4) executing the network transmission applications installed in the first host and the second host;
(5) establishing a network transmission channel with a specific network communication port between the first host and the second host;
(6) automatically accessing the international positions (IP) of the first host and the second host and a specific code of the specific network communication port by the network transmission applications;
(7) determining whether to move and copy the files and data from the first host to the second host, if yes, proceeding to step (8), otherwise, proceeding to step (9);
(8) moving files and copying data from the first host to the second host via the network transmission channel;
(9) determining whether to move and copy the files and data from the second host to the first host, if yes, proceeding to step (10), otherwise, proceeding to step (11);
(10) moving files and copying data from the second host to the first host through the network transmission channel; and
(11) determining whether the file transmission and data copy are completed, if yes, ending the steps, otherwise, proceeding to step (7).

23. The file transmitting method of claim 22, wherein the step (8) further comprising the detailed steps of:
(81) using the first operation device to drag the files and data in the first display device;
(82) further dragging the files and data out of the screen of the first display device; and
(83) the files and data being moved and copied to the second host.

24. The file transmitting method of claim 22, wherein the step (8) further comprising the detailed steps of:
(81a) opening a default desktop window of the second host through the network transmission application;
(82a) moving and copying the files and data to the default desktop window; and
(83a) the files and data being moved and copied to the second host.

25. The file transmitting method of claim 22, wherein the step (8) further comprising the detailed steps of:
(81b) opening an Explore of the second host through the network transmission application;
(82b) moving and copying the files and data to the Explore; and
(83b) the files and data being moved and copied to the second host.
